(19) United States
(12) Patent Application Publication
(10) Pub. No.: US 2025/0216653 A1
(43) Pub. Date: Jul. 3, 2025

(54) OPTICAL SYSTEM AND ELECTRONIC DEVICE FOR DEBLURRING

(71) Applicant: Samsung Electronics Co., Ltd., Suwon-si (KR)

(72) Inventors: Viktoriia KAIDARAKOVA, Solmanovo (RU); Elena MALINOVSKAYA, Moscow (RU); Stepan IVANOV, St. Petersburg (RU)

(73) Assignee: Samsung Electronics Co., Ltd., Suwon-si (KR)

(21) Appl. No.: 18/999,253

(22) Filed: Dec. 23, 2024

(30) Foreign Application Priority Data
Dec. 27, 2023 (RU) 2023135615
Oct. 15, 2024 (KR) 10-2024-0140620
Dec. 9, 2024 (KR) 10-2024-0181260

(51) Int. Cl. G02B 13/00; G02B 9/62; G03B 30/00; H04N 23/68

(52) U.S. Cl. CPC G02B 13/0045; G02B 9/62; G03B 30/00; H04N 23/683

(57) ABSTRACT

An optical system includes a lens assembly comprising a plurality of lenses, and an image sensor configured to sense light passing through the lens assembly, wherein, for a point light source positioned in a central zone of a field of view (FOV), a full width at half maximum (FWHM) of a point spread function (PSF) of the optical system is greater than an FWHM of a PSF of a reference system, wherein the reference system comprises a same number of lenses as the plurality of lenses and another image sensor and is configured to optimize a modulation transfer function (MTF), and wherein, for a point light source positioned in an edge zone of the FOV, the FWHM of the PSF of the optical system is smaller than the FWHM of the PSF of the reference system.

### CROSS-REFERENCE TO RELATED APPLICATIONS

This application claims the benefit under 35 USC § 119 (a) of Russian Patent Application No. 2023135615 filed on Dec. 27, 2023 in the Russian Federal Service for Intellectual Property, Korean Patent Application No. 10-2024-0140620 filed on Oct. 15, 2024 in the Korean Intellectual Property Office, and Korean Patent Application No. 10-2024-0181260 filed on Dec. 9, 2024 in the Korean Intellectual Property Office, the entire disclosures of which are incorporated herein by reference for all purposes.

### BACKGROUND

### 1. Field

The following disclosure relates to an optical system and electronic device for deblurring.

### 2. Description of Related Art

With advances in optical systems, the size of optical systems and image sensor pixels provided in electronic devices have become smaller, while the resolution of generated images has increased. For example, in image sensor arrays, the pixel size may be less than 0.64 μm, which is a value smaller than the red wavelength of visible light. Thus, lenses constructed using traditional optical calculation techniques inherently have a resolution that is not sufficient for such image sensors. However, when attempting to further increase the resolution of generated images, optical systems may not provide appropriate resolution, may not accurately or efficiently restore images generated by an image sensor, and/or may not efficiently implement existing image restoration methods.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an optical system includes a lens assembly comprising a plurality of lenses, and an image sensor configured to sense light passing through the lens assembly, wherein, for a point light source positioned in a central zone of a field of view (FOV), a full width at half maximum (FWHM) of a point spread function (PSF) of the optical system is greater than an FWHM of a PSF of a reference system, wherein the reference system comprises a same number of lenses as the plurality of lenses and another image sensor and is configured to optimize a modulation transfer function (MTF), and wherein, for a point light source positioned in an edge zone of the FOV, the FWHM of the PSF of the optical system is smaller than the FWHM of the PSF of the reference system.

One or more of the plurality of lenses of the optical system may have a same shape as one or more of the plurality of lenses of the reference system.

A ratio of a flange back length (FBL) of the optical system to an axial distance (TTL) from an object-side surface of a lens positioned closest to an object side among the plurality of lenses to the image sensor may be greater than 0.10, and a ratio of the FBL of the optical system to a focal length (FL) of the optical system may be greater than 0.14.

A length from a center of the FOV of the optical system to a vertex of the FOV of the optical system may be denoted as F, a defocus value for each position of an image formed in the image sensor may be at a maximum at a position where a distance from the center of the FOV is less than 1.0 F, and the defocus value for each position of the image formed in the image sensor may be at a minimum at a position where the distance from the center of the FOV is greater than 0.0 F.

A length from a center of the FOV of the optical system to a vertex of the FOV of the optical system may be denoted as F, and a coma value for each position of an image formed in the image sensor may be at a maximum at a position where a distance from the center of the FOV is less than 1.0 F.

For a zone of 80% or more of the FOV of the optical system, a deviation of the FWHM of the PSF of the optical system may be within 30%.

For a zone of ⅓ or more of a zone positioned in a diagonal direction of the FOV of the optical system, a deviation of the FWHM of the PSF of the optical system may be within 30%. A distortion of the optical system may be less than 5%.

The plurality of lenses may include a first lens that is positioned closest to an object side among the plurality of lenses and has a positive refractive power, a second lens that is positioned closer to an image side than the first lens and has a negative refractive power, a third lens that is positioned closer to the image side than the second lens and has a positive refractive power, a fourth lens that is positioned closer to the image side than the third lens and has a positive refractive power, a fifth lens that is positioned closer to the image side than the fourth lens and has a negative refractive power, and a sixth lens that is positioned closer to the image side than the fifth lens and has a negative refractive power.

The first to sixth lenses may be aspherical lenses.

The optical system may include an infrared (IR) filter disposed between the sixth lens and the image sensor and may be configured to block IR radiation.

The first to sixth lenses may be formed of plastic.

The optical system may include an additional optical element placed on a surface of one or more of the plurality of lenses.

The additional optical element may include any one or any combination of any two or more of a diffractive optical element (DOE), a mirror, a holographic optical element (HOE), and a metalens.

The plurality of lenses may include a first lens that is positioned closest to an object side among the plurality of lenses and has a negative refractive power, a second lens that is positioned closer to an image side than the first lens and has a positive refractive power, a third lens that is positioned closer to the image side than the second lens and has a negative refractive power, a fourth lens that is positioned closer to the image side than the third lens and has a positive refractive power, and a fifth lens that is positioned closer to the image side than the fourth lens and has a negative refractive power.

An electronic device may include the optical system, and one or more processors configured to deblur a plurality of zones of an image formed in the image sensor using a single PSF obtained in any one of the plurality of zones.

In one or more general aspects, an optical system includes a lens assembly comprising a plurality of lenses, and an image sensor configured to sense light passing through the lens assembly, wherein a ratio of a flange back length (FBL) of the optical system to an axial distance (TTL) from a portion farthest from the image sensor among the plurality of lenses to the image sensor is greater than 0.10, and wherein a ratio of the FBL of the optical system to a focal length (FL) of the optical system is greater than 0.14.

In one or more general aspects, an optical system includes a lens assembly comprising a plurality of lenses, and an image sensor configured to sense light passing through the lens assembly, wherein a distortion of the optical system is less than 5%, and wherein, for a zone of ⅓ or more of a zone positioned in a diagonal direction of a field of view (FOV) of the optical system, a deviation of a full width at half maximum (FWHM) of a point spread function (PSF) of the optical system is within 30%.

In one or more general aspects, an electronic device includes an optical system comprising a plurality of lenses, wherein a ratio of a flange back length (FBL) of the optical system to an axial distance (TTL) from an object-side surface of a lens positioned closest to an object side among the lenses to an image sensor is greater than 0.10, and a ratio of the FBL of the optical system to a focal length (FL) of the optical system is greater than 0.14, and the image sensor configured to sense light passing through the lenses and generate an image, and one or more processors configured to generate a deblurred image by deblurring a plurality of zones of the image generated by the image sensor using a single point spread function (PSF) obtained in any one of the plurality of zones.

For the deblurring, the one or more processors may be configured to deblur the plurality of zones of the image generated by the image sensor without using a modulation transfer function (MTF) obtained in any one of the plurality of zones.

Other features and aspects will be apparent from the following detailed description, the drawings, and the claims.

### BRIEF DESCRIPTION OF THE DRAWINGS

FIGS. 1A and 1B illustrate an example of generating a spread spot image in an image sensor after light emitted from a point source passes through a lens assembly.

FIGS. 2A and 2B illustrate a plurality of point sources, and a blurred image formed for each zone in an image sensor when light emitted from a corresponding point source passes through a lens assembly according to an example.

FIGS. 3A and 3B illustrate a modulation transfer function (MTF) and a point spread function (PSF) for each zone by a lens assembly according to an example.

FIGS. 4A and 4B illustrate a plurality of point sources, and a blurred image formed for each zone in an image sensor when light emitted from a corresponding point source passes through a lens assembly according to an example.

FIGS. 5A and 5B illustrate a PSF and an MTF for each zone by a lens assembly according to an example.

FIG. 6 illustrates an example method of evaluating a size of a spread spot image generated in an image sensor by light emitted from a point source.

FIG. 7 illustrates a blurring value for each field coordinate of an image formed by a lens assembly according to an example and a blurring value for each field coordinate of an image formed by a lens assembly according to an example.

FIG. 8 illustrates an electronic device according to an example.

FIG. 9 illustrates an optical system according to an example.

FIG. 10 illustrates a PSF for each zone of an optical system according to an example.

FIGS. 11A and 11B illustrate an arrangement structure of an optical system according to an example, and an arrangement structure of an optical system according to an example.

FIG. 12 illustrates an arrangement structure of an optical system according to an example, and a relative defocus value according to a field coordinate of an image sensor.

FIG. 13 illustrates an arrangement structure of an optical system according to an example, and a relative coma value according to a field coordinate of an image sensor.

FIG. 14 illustrates an optical system according to an example.

FIG. 15 illustrates an optical system according to an example.

FIG. 16 illustrates a PSF for each zone of an optical system according to an example.

FIGS. 17A and 17B illustrate an arrangement structure of an optical system according to an example, and an arrangement structure of an optical system according to an example.

FIG. 18 illustrates a relative defocus value according to a field coordinate of an image sensor of an optical system according to an example.

FIG. 19 illustrates a relative coma value according to a field coordinate of an image sensor of an optical system according to an example.

FIG. 20 illustrates a blurring value formed by an optical system according to an example, and a blurring value formed by a lens assembly according to an example.

FIG. 21 illustrates a blurring value formed by an optical system according to an example, and a blurring value formed by a lens assembly according to an example.

FIG. 22 illustrates a blurring value formed by an optical system according to an example, and a blurring value formed by a lens assembly according to an example.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms used herein including technical or scientific terms have the same meanings as those generally understood consistent with and after an understanding of the present disclosure. Terms, such as those defined in commonly used dictionaries, should be construed to have meanings matching with contextual meanings in the relevant art and the present disclosure, and are not to be construed as an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Due to manufacturing techniques and/or tolerances, variations of the shapes shown in the drawings may occur. Thus, the examples described herein are not limited to the specific shapes shown in the drawings, but include changes in shape that occur during manufacturing.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

Hereinafter, examples will be described in detail with reference to the accompanying drawings. When describing the examples with reference to the accompanying drawings, like reference numerals refer to like components and a repeated description related thereto will be omitted.

A component, which has the same common function as a component included in any one example, will be described by using the same name in other examples. Unless disclosed to the contrary, the configuration disclosed in any one example may be applied to other examples, and the specific description of the repeated configuration will be omitted.

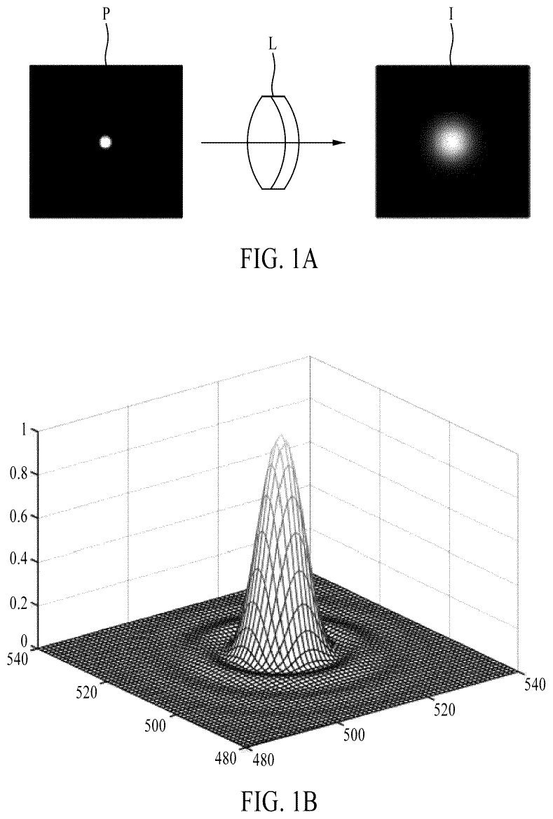

FIGS. 1A and 1B illustrate an example of generating a spread spot image in an image sensor after light emitted from a point source passes through a lens assembly.

Referring to FIGS. 1A and 1B, light emitted from a point source P passes through a lens assembly L and generates a spread spot image in an image sensor I as shown in FIG. 1A. For example, an image formed in the image sensor I has a spread shape with intensity distribution, not the compact shape of the point source P. FIG. 1B is an example graph expressing the intensity of light sensed by the image sensor I for each position of the image sensor I. Such diffusion of light may lower the resolution of images. Here, the resolution refers to the minimum distance between two points on an object that is identifiable by an optical system, and as the minimum distance decreases, the resolution may increase. The resolution is a significant element that determines the performance of an optical system together with the magnification, and an optical system with low resolution may not observe a fine portion of an object even with high magnification. For example, in an image captured by an optical system with low resolution, two images adjacent to each other at a predetermined level or higher are unresolvable and expressed as a single object. Accordingly, to acquire a high-quality image, an optical system of one or more embodiments may generate images having a higher resolution.

Meanwhile, optical systems inherently have aberrations, and an aberration tends to increase away from the central zone of an optical system. An aberration is an element to evaluate the quality of an optical system. To reduce aberrations, typical optical systems may improve the resolution of an image generated in the central zone, and thus, the resolution value may considerably decrease at a zone closer to the edge zone of the image.

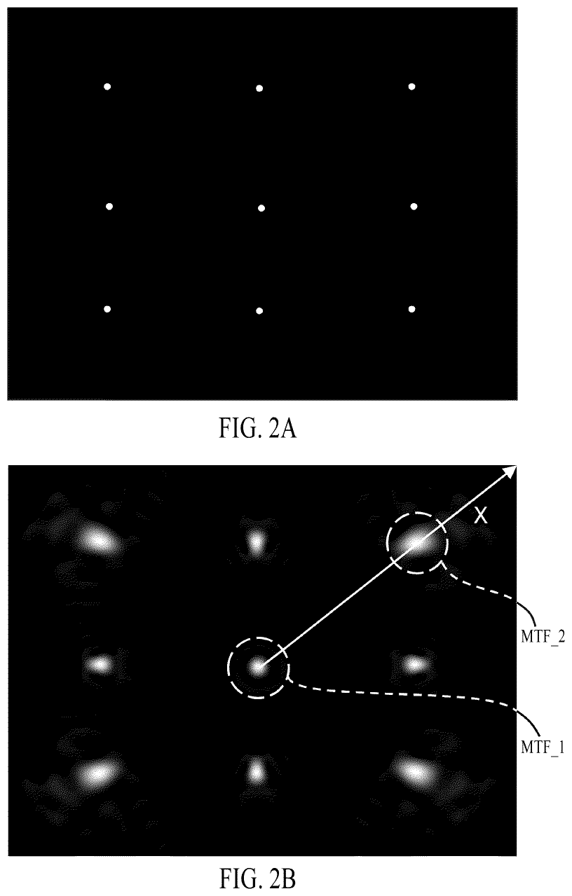

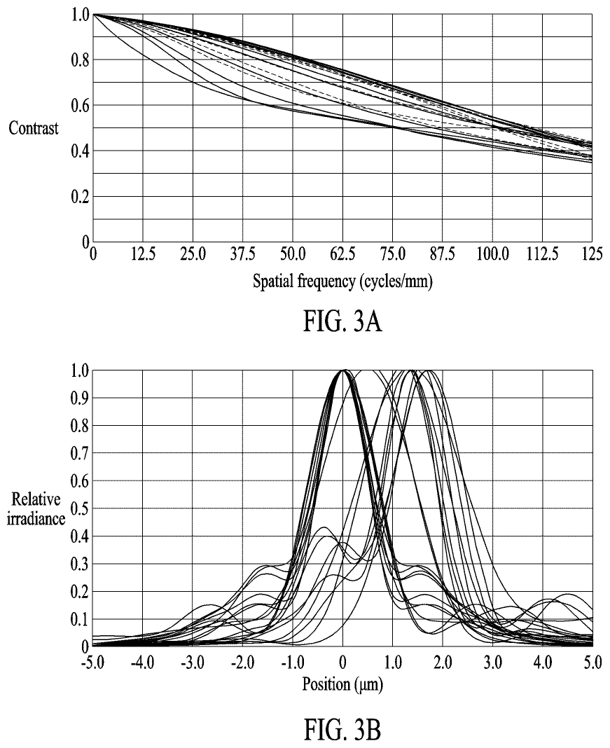

FIGS. 2A and 2B illustrate a plurality of point sources (e.g., FIG. 2A), and a blurred image (e.g., FIG. 2B) formed for each zone in an image sensor when light emitted from a corresponding point source passes through a lens assembly according to an example. FIGS. 3A and 3B illustrate a modulation transfer function (MTF) (e.g., FIG. 3A) and a point spread function (PSF) (e.g., FIG. 3B) for each zone by a lens assembly according to an example.

Referring to FIGS. 2A to 3B, an image (see FIG. 2B) acquired by capturing a plurality of point sources (see FIG. 2A) through a lens assembly according to an example is shown. The lens assembly according to an example may be construed as a lens assembly for MTF optimization that is widely used to evaluate the quality of an optical system. The lens assembly for MTF optimization may be, for example, a lens configured to maximize the MTF value in the central zone of the lens assembly by adjusting the positional relationship among a plurality of lenses provided in a set number and shape, within a space of a set size. Referring to FIG. 2B, the central zone MTF_1 and the edge zone MTF_2 of the image captured by the lens assembly according to an example may be considerably different in the size and shape of a spread spot. The image of the spread spot in the central zone MTF_1 may have a symmetrical shape and a small size (e.g., small diffusion), whereas the image of the spread spot in the edge zone MTF_2 may have a larger (e.g., more spread) and asymmetrical shape.

FIG. 3A illustrates MTFs of the lens assembly according to an example, showing contrast according to a spatial frequency. An MTF represents a response of an optical system to a periodic pattern of light passing through the optical system according to a spatial frequency. As the MTF value increases, the resolution of the optical system increases, and as the spatial frequency value increases, the contrast decreases as shown. Accordingly, optical systems may be configured to have an MTF value that decreases as slowly or late as possible even when the spatial frequency value increases. The MTF value is also related to the aberration described above, and thus, typically, the MTF of the central zone is higher than the MTF of the edge zone. Therefore, to increase the maximum value of the MTF, typical optical systems may improve the resolution of an image generated in the central zone, and thus, the resolution may considerably decrease in a zone close to the edge of the image.

FIG. 3B illustrates PSFs of the lens assembly for MTF optimization as described above, wherein the horizontal axis denotes a position away from the energy center, and the vertical axis denotes the relative irradiance of light incident to the image sensor. Here, the position may be construed as the distance X (see FIG. 2B) from the center of a field of view (FOV) of the optical system to the vertex of the FOV of the optical system. For example, the position may also be construed as the diagonal distance from the center of the image sensor to its corner. A PSF is related to a response of the optical system to a point source, and may be construed as the characteristic of a spread spot generated by the point source on an image of the optical system. The PSF may be construed as a function representing a light intensity distribution obtained from an imaging plane (e.g., the image sensor) after inputted by the point light source and transmitted through the optical system. Using PSFs, the original image may be restored through the image formed on the imaging plane. PSFs may vary depending on geometric aberrations of the optical system and diffraction of light at the aperture stop of the optical system.

As learned through the PSFs of FIG. 3B, the optical system for MTF optimization may have a different PSF for each zone. As learned through the image shown in FIG. 2B and the PSF of FIG. 3B, the optical system for MTF optimization may have different degrees of diffusion in the central zone and the edge zone, for example, at a ratio of 1:3. Accordingly, by having the different degrees of diffusion in the central zone and the edge zone, the typical optical system for MTF optimization may generate an image having considerably more blurring values in the edge zone than in the central zone.

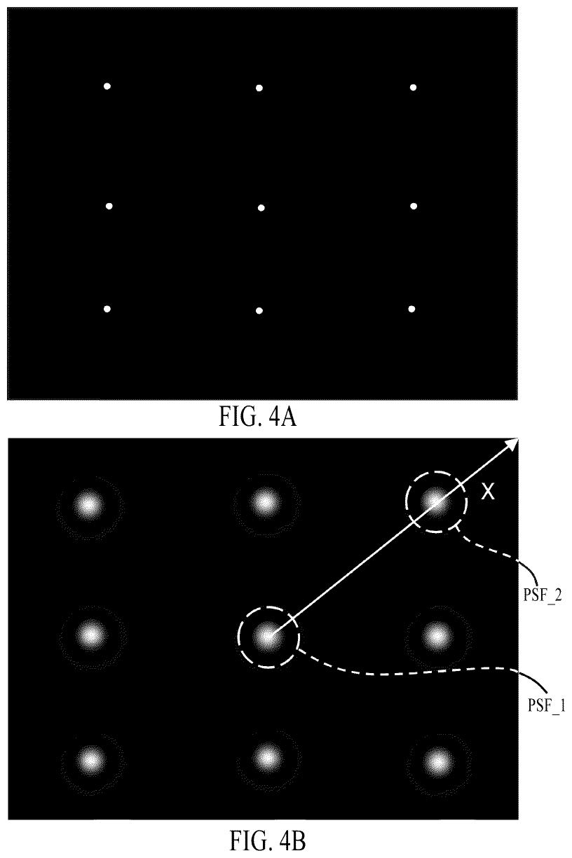

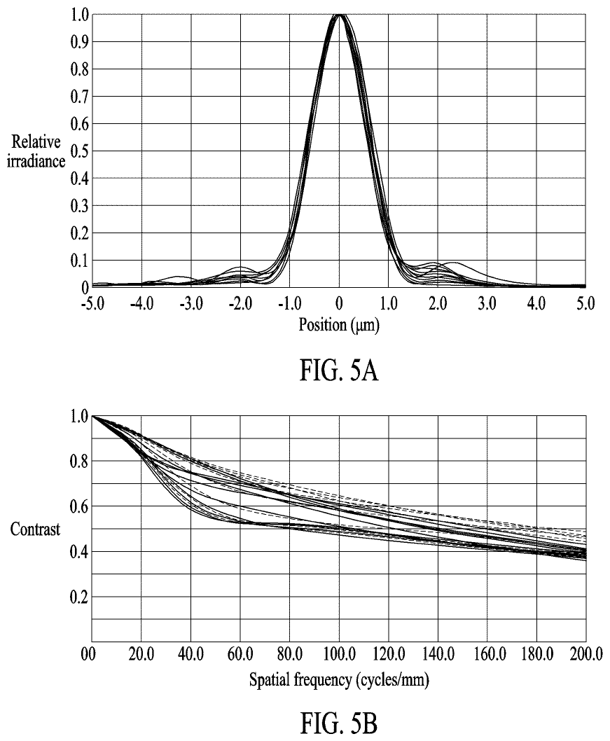

FIGS. 4A and 4B illustrate a plurality of point sources, and a blurred image formed for each zone in an image sensor when light emitted from a corresponding point source passes through a lens assembly according to an example. FIGS. 5A and 5B illustrate a PSF and an MTF for each zone by a lens assembly according to an example.

Referring to FIGS. 4A to 5B, an image (e.g., FIG. 4B) acquired by capturing a plurality of point sources (e.g., FIG. 4A) through a lens assembly according to an example is shown. The lens assembly according to an example may be construed as a lens assembly for PSF uniformization. Referring to FIG. 4B, it may be learned that the central zone PSF_1 and the edge zone PSF_2 of the image captured by the lens assembly of one or more embodiments have spread spots that are uniform in size and shape, compared to the image of FIG. 2B.

Referring to FIG. 5A, it may be learned that irrespective of position X (see FIG. 4B), the lens assembly of one or more embodiments may result in PSFs having a generally uniform shape in all zones. Thus, the lens assembly of one or more embodiments may result in the image haing similar blurring values in the edge zone and the central zone.

Meanwhile, referring to FIG. 5B, it may be learned that compared to MTFs (see FIG. 3A) of a general optical system, the contrast decreases relatively quickly as the spatial frequency value increases. As described above, the optical system according to one or more embodiments may be configured not for MTF optimization but for PSF uniformization, unlike a typical optical system.

By typical standards, the optical system according to an example may be considered as having lower performance than the typical optical systems (see FIGS. 2A to 3B) according to an example, but the optical system of one or more embodiments has an advantage of having a uniform image quality over the entire FOV including the edge zone. When the PSFs of the optical system are uniform in all zones, the optical system of one or more embodiments may efficiently restore all the zones of the image may be efficiently restored using only a single PSF. Accordingly, through image restoration, the optical system of one or more embodiments may acquire a high quality of image for both the central zone and the edge zone, and may achieve faster image restoration. According to an example, by reducing the amount of image processing, the optical system of one or more embodiments may allow an image processor to be miniaturized, which may be advantageous in miniaturizing and reducing the weight of electronic devices (e.g., mobile phones, compact cameras, laptop computers, webcams, automotive cameras, and/or done cameras) implementing the image processor. Examples of such advantages of the optical system of one or more embodiments will be described with reference to the following drawings.

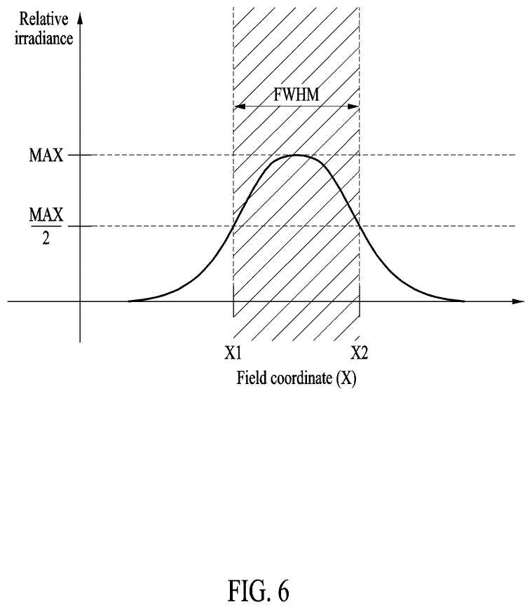

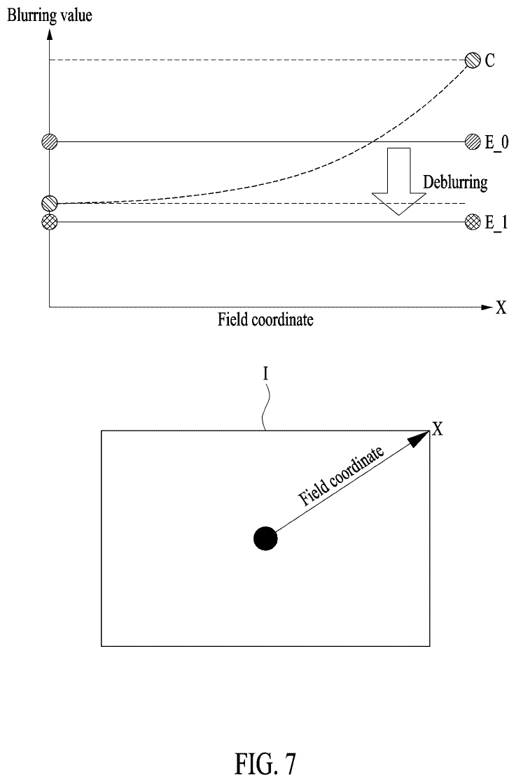

FIG. 6 illustrates an example method of evaluating the size of a spread spot image generated in an image sensor by light emitted from a point source. FIG. 7 illustrates a blurring value for each field coordinate of an image formed by a lens assembly according to an example and a blurring value for each field coordinate of an image formed by a lens assembly according to an example.

Referring to FIGS. 6 and 7, a blurring value for each field coordinate of an image expressed based on a PSF is shown. Referring to FIG. 6 first, full width at half maximum (FWHM) is one of the methods of expressing blurring values, and FWHM may be used to figure a blurring value as a width X2-X1 at a half height MAX/2 of the maximum value MAX of a PSF. That is, it may be construed that more blurring occurs as FWHM increases. Using an FWHM for a PSF measured for each zone as a representative value, the blurring value for each zone may be represented as in FIG. 7. The field coordinate X in FIG. 7 may be construed as the distance from the center of an FOV of an optical system to the vertex of the FOV of the optical system. For example, the field coordinate X may also be construed as the diagonal distance from the center of the image sensor I to the vertex of the image sensor I.

In FIG. 7, a graph C shows a blurring value for each field coordinate of an image formed by the typical lens assembly according to an example. It may be learned that in the case of a typical lens assembly for MTF optimization, the blurring value increases from the central zone toward the edge zone, as shown in the graph C.

A graph E_0 shows a blurring value for each field coordinate of an image formed by the lens assembly according to an example. It may be learned that in the case of a lens assembly for PSF uniformization, the blurring value is uniform in a predetermined range from the central zone to the edge zone, as shown in the graph E_0. Meanwhile, although lower blurring values are desirable to improve image quality, it may be difficult to lower blurring values in all zones due to various aberrations and diffractions that inevitably occur in an optical system. Therefore, according to an example, the lens assembly of one or more embodiments may be configured to reduce the blurring value in the edge zone even when the blurring value of the central zone is somewhat higher. Further, such a configuration of the lens assembly of one or more embodiments may uniformize a PSF and the blur amount in each zone.

As shown, for example, the FWHM of the PSF of the optical system for a point source positioned in the central zone of the FOV of the optical system may be configured to be larger than the FWHM of the PSF of the optical system according to an example (e.g., the optical system for MTF optimization). For example, the FWHM of the PSF of the optical system for a point source positioned in the edge zone of the FOV of the optical system may be smaller than the FWHM of the PSF of the optical system according to an example (e.g., the optical system for MTF optimization). For example, the size of the spread spot in the central zone PSF_1 (see FIG. 4B) of the image may be greater than the size of the spread spot in the central zone MTF_1 (see FIG. 2B) of the image captured by the lens assembly according to an example. For example, the size of the spread spot in the edge zone PSF_2 (see FIG. 4B) of the image captured by the lens assembly of one or more embodiments may be smaller than the size of the spread spot in the edge zone MTF_2 (see FIG. 2B) of the image captured by the typical lens assembly according to an example.

For example, to reduce hardware-induced blurring values in a plurality of zones (e.g., all zones) including the central zone, an image restoration technique may be used. For example, image restoration techniques to enhance resolution may include a “blind” method and a “non-blind” method.

The blind method may not use information on PSFs of the optical system, which introduces noise and distortion in a detected useful signal. The non-blind method may restore an image using a deconvolution method. According to an example, a non-blind method using PSFs may be used as a deblurring technique for image restoration.

For example, deblurring may be performed using a PSF obtained for each zone of an image. Using this method, a high-quality image with high resolution may be acquired. However, the method that uses a different PSF for each zone of the image may require a lot of time and computation cost and thus, has an issue of being difficult to use in miniaturized electronic devices such as mobile phone cameras.

According to an example, the optical system of one or more embodiments may use a single PSF for the entire image to restore the image, thereby remarkably reducing the time and cost described above. Meanwhile, a typical method using a single PSF for the entire image may have the disadvantage of hardly contributing to lowering blurring values in remaining zones excluding some zones when the PSF for each zone of the image differs greatly. In contrast, the optical system of one or more embodiments with uniform PSFs according to an example may remove blurring values with high efficiency for all zones, as shown in a graph E_1 of FIG. 7A even when a single PSF is used, and thus the optical system of one or more embodiments may acquire a high-quality image and reduce the time and cost of image restoration at the same time. For example, by reducing the amount of image processing, the optical system of one or more embodiments may allow an image processor to be miniaturized, which may help miniaturize and reduce the weight of electronic devices (e.g., mobile phones, compact cameras, laptop computers, webcams, automotive cameras, and/or done cameras) implementing the optical system. The test result confirmed that applying a single PSF and using deep Wiener deconvolution and Bayesian-based iterative method for an image acquired through the optical system having the characteristics of the graph E_0 according to an example may improve image quality as in the graph E_1. The graph E_1 shows lower blurring values than the graph C in all zones including not only the central zone but also the edge zone.

According to an example as described above, the effects described above may be expected by configuring an optical system based on PSFs used for image restoration rather than MTFs used as a design index for typical optical systems.

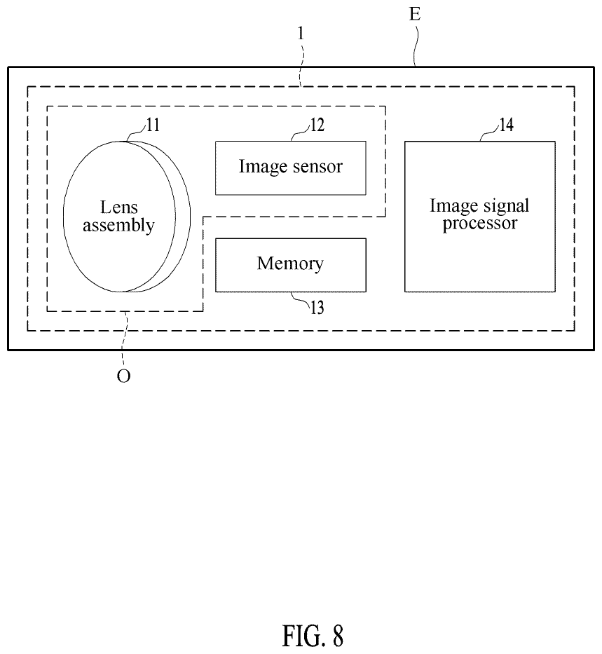

FIG. 8 illustrates an electronic device according to an example.

Referring to FIG. 8, an electronic device E may be, for example, a mobile phone, a compact camera, a laptop computer, a webcam, an automotive camera, and/or a done camera, but is not limited thereto. The electronic device E may include a camera module 1. The camera module 1 may include a lens assembly 11, an image sensor 12 (e.g., one or more sensors), a memory 13 (e.g., one or more memories), and an image signal processor 14 (e.g., one or more processors). Meanwhile, the lens assembly 11 and the image sensor 12 may also be collectively referred to as an optical system O.

The lens assembly 11 may collect light emitted from a subject to be captured. The lens assembly 11 may include one or more lenses. Examples of the configuration and arrangement of the lens assembly 11 will be described with reference to the following drawings.

The image sensor 12 may sense the light passing through the lens assembly 11. The image sensor 12 may convert the light emitted or reflected from the subject and transmitted through the lens assembly 11 into an electrical signal, thereby acquiring an image corresponding to the subject. The image sensor 12 may include, for example, one or more image sensors selected from image sensors having different properties, such as a red, green and blue (RGB) sensor, a black and white (BW) sensor, an infrared (IR) sensor, and/or an ultraviolet (UV) sensor, a plurality of image sensors having the same properties, and/or a plurality of image sensors having different properties. Each image sensor included in the image sensor 12 may be implemented, for example, using a charged-coupled device (CCD) sensor and/or a complementary metal-oxide-semiconductor (CMOS) sensor.

PSF information of the lens assembly 11 may be stored in the memory 13. The information stored in the memory 13 may be transmitted to the image signal processor 14. For example, the memory 13 may store at least a portion of images acquired through the image sensor 12 at least temporarily for subsequent image processing tasks. For example, when image acquisition is delayed due to a shutter and/or a plurality of images are acquired at high speed, the acquired original images (e.g., Bayer-patterned images or high-resolution images) may be stored in the memory 13, copy images corresponding thereto (e.g., low-resolution images) may be previewed through a display module of the electronic device E. Thereafter, when a designated condition (e.g., receiving an image enlargement instruction or entering a capturing idle period) is satisfied, for example, at least a portion of the original images stored in the memory 13 may be obtained by the image signal processor 14, and a deblurring task may be performed thereon.

The image signal processor 14 may perform at least one image processing (e.g., deblurring) on an image acquired through the image sensor 12 and/or an image stored in the memory 13. For example, the image signal processor 14 may deblur a plurality of zones (e.g., all zones) of an image formed in the image sensor 12 using a single PSF obtained for any one zone (e.g., the central zone or the edge zone) of the plurality of zones. The image signal processor 14 may perform a control (e.g., an exposure time control and/or a read-out timing control) on at least one (e.g., the image sensor 12) of the components included in the camera module 1. The images processed by the image signal processor 14 may be stored again in the memory 13 for further processing or provided to an external component (e.g., another electronic device E or a server) of the camera module 1. According to an example, the image signal processor 14 may be configured as a separate processor that operates independently of a main processor of the electronic device E, but is not limited thereto. The image signal processor 14 may also be configured as part of a processor capable of performing another function independent of the camera module 1 in the electronic device E.

The image signal processor 14 may restore an image by performing a deblurring task on an image of a plurality of zones (e.g., all zones) using a single PSF based on, for example, the information collected from the image sensor 12. When the image formed in the image sensor 12 has uniform blurring values, the electronic device E of one or more embodiments may perform the deblurring task efficiently in both the central zone and the edge zone of the FOV of the optical system O even using a single PSF, and the electronic device E of one or more embodiments may acquire an image with uniform quality over the entire FOV. Further, by using a single PSF, the electronic device E of one or more embodiments may increase the processing speed of the image signal processor 14 and reduce the computation cost. The image signal processor 14 may perform, for example, various standard non-blind image deblurring algorithms (e.g., the algorithm described at https://github.com/dongjxjx/dwdn). The image signal processor 14 may restore images using, for example, Wiener deconvolution-based algorithms that are based on the spread spot characteristics. The image signal processor 14 may restore images using, for example, deep Wiener deconvolution and/or Bayesian-based iterative method, but is not limited thereto.

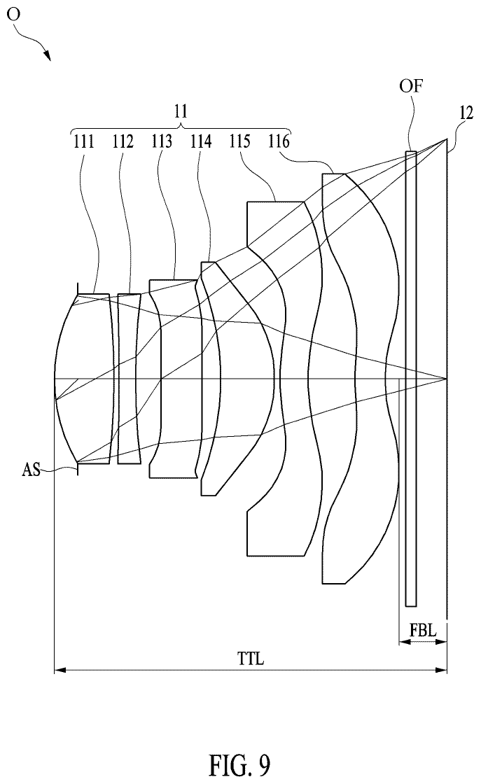

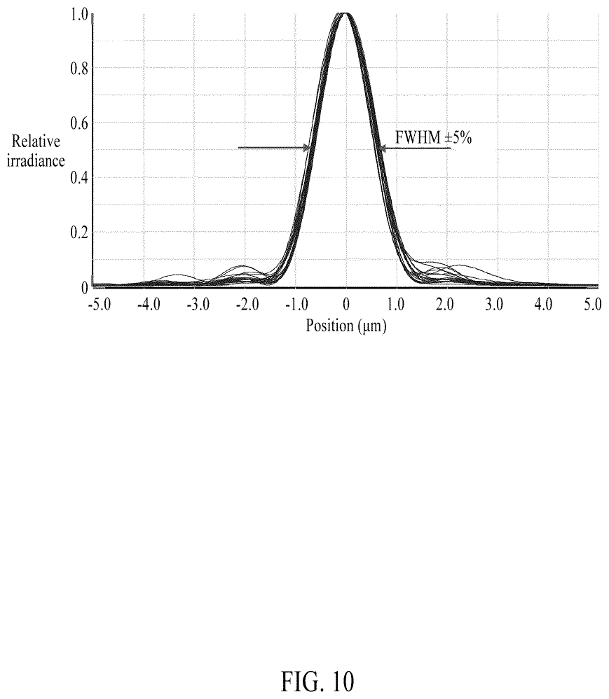

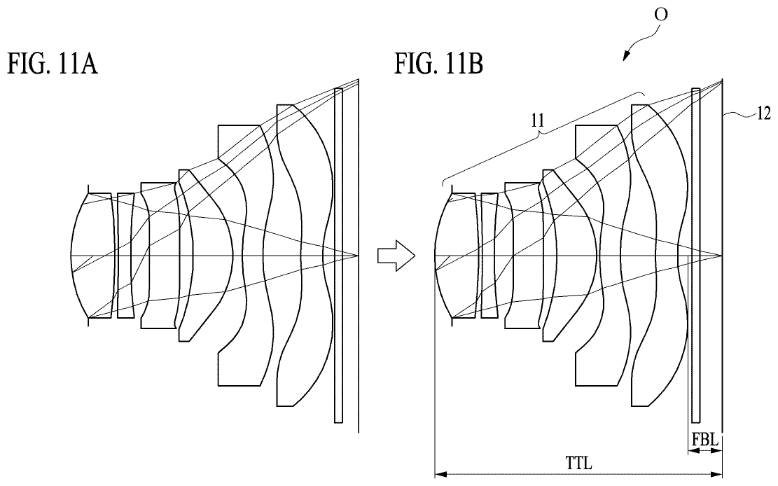

FIG. 9 illustrates an optical system according to an example. FIG. 10 illustrates a PSF for each zone of an optical system according to an example. FIGS. 11A and 11B illustrate an arrangement structure of an optical system according to an example, and an arrangement structure of an optical system according to an example.

Referring to FIGS. 9 to 11B, an optical system O according to an example may include an aperture stop AS, the lens assembly 11, an optical filter OF, and the image sensor 12.

The lens assembly 11 may include a plurality of lenses. For example, at least one (e.g., all) of the plurality of lenses may be an aspherical lens. First to sixth lenses 111 to 116 may be formed of plastic, but are not limited thereto. For example, the plurality of lenses may be formed of glass and/or an optical ceramic.

The plurality of lenses may include (i) a first lens 111 that is positioned closest to an object side among the plurality of lenses and has a positive (+) refractive power, (ii) a second lens 112 that is positioned closer to an image side than the first lens 111 and has a negative (−) refractive power, (iii) a third lens 133 that is positioned closer to the image side than the second lens 122 and has a positive refractive power, (iv) a fourth lens 114 that is positioned closer to the image side than the third lens 113 and has a positive refractive power, (v) a fifth lens 115 that is positioned closer to the image side than the fourth lens 114 and has a negative refractive power, and (vi) a sixth lens 116 that is positioned closer to the image side than the fifth lens 115 and has a negative refractive power. For example, the lens assembly 11 may include the first to sixth lenses 111 to 116 described above, that is, a total of six lenses.

The optical filter OF may be disposed between the sixth lens 116 and the image sensor 12. For example, the optical filter OF may include an IR filter that is disposed between the sixth lens 116 and the image sensor 12 to block IR radiation. For example, the optical filter OF may be formed of glass, but is not limited thereto. For example, the optical filter OF may have no effect on the focal length of the optical system O according to an example.

The optical system O of one or more embodiments may have a structure in which the PSF in the central zone increases and the PSF in the edge zone decreases, compared to a typical optical system (or reference system) according to an example for MTF optimization (e.g., see FIG. 11A). Through this configuration, the deviation of the FWHM of the PSF for each zone of the optical system O may be, for example, within 30% (e.g., within 5%) as shown in FIG. 10. A threshold value for the deviation of the FWHM of the PSF may be determined to be 30% in the development process, and it was confirmed that as the deviation within the threshold value described above decreases, the efficiency of image restoration using a single PSF gradually increases.

For example, as shown in FIG. 11A, the reference system (e.g., FIG. 11A) may include the same number of lenses as the plurality of lenses 11 of the optical system O according to one or more embodiments (e.g., FIG. 11B) and an image sensor, and may be configured for MTF optimization. For example, at least one of the plurality of lenses 11 of the optical system O according to one or more embodiments may have the same shape as at least one of the plurality of lenses of the reference system. For example, the plurality of lenses 11 and the image sensor 12 of the optical system O according to an example may be configured to have the same shapes as the plurality of lenses and the image sensor of the reference system, respectively, and have a different positional relationship for PSF uniformization.

According to an example, it may be configured so that the FWHM of the PSF of the optical system O for a point source positioned in the central zone of the FOV is greater than the FWHM of the PSF of the reference system and the FWHM of the PSF of the optical system O for a point source positioned in the edge zone of the FOV is smaller than the FWHM of the PSF of the reference system. To this end, the optical system O according to one or more embodiments may satisfy Equation 1 and Equation 2 below, for example, within the constraints of a physical space in which the optical system O is to be accommodated.

FBL/TTL>0.10 Equation 1:

FBL/FL>0.14 Equation 2:

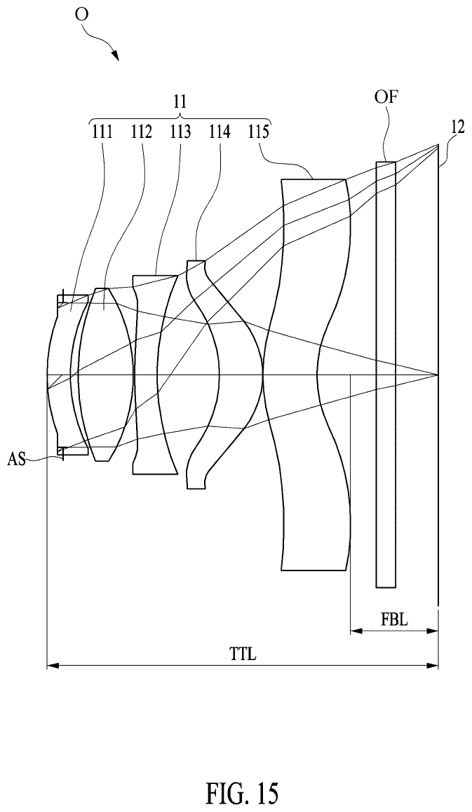

Here, FBL denotes the flange back length of the optical system O (e.g., the distance from the closest to the image point of the image-side surface of the last lens in the optical system O (e.g., the sixth lens 116 of FIG. 9 or the fifth lens 115 of FIG. 15) to the image plane (e.g., the image sensor 12)), TTL denotes the axial distance from the object-side surface of a lens positioned closest to the object side among the plurality of lenses (e.g., the first lens 111) to the image sensor 12, and FL denotes the focal length of the optical system O. In contrast to FBL, BFL denotes the back focal length of the optical system O (e.g., the distance from the image-side surface of the last lens in the optical system O to the image plane along the optical axis).

As in Equation 1, the ratio of (i) the flange back length (FBL) of the optical system O and (ii) the axial distance (TTL) from the object-side surface of the lens positioned closest to the object side among the plurality of lenses to the image sensor 12 may be greater than 0.10. For example, as shown in FIGS. 11A and 11B, compared to the reference system for MTF optimization, the ratio of FBL/TTL may increase in the optical system O according to one or more embodiments so that the FWHM of the PSF has a deviation within a predetermined range.

As in Equation 2, the ratio of (i) the flange back length (FBL) of the optical system O and (ii) the focal length (FL) of the optical system O may be greater than 0.14. For example, as shown in FIGS. 11A and 11B, compared to the reference system for MTF optimization, the ratio of FBL/FL may increase in the optical system O according to one or more embodiments so that the FWHM of the PSF has a deviation within a predetermined range.

By the configuration described above, the optical system O may be closer to telecentric than the reference system. For example, the angel of main rays incident to the image sensor 12 may be smaller over the entire FOV, and thus the optical system O of one or more embodiments may more easily process off-axis aberrations (e.g., coma aberrations), and the image quality may be uniformized over the entire FOV as the PSF for the edge zone of the FOV is similar to the PSF in the central zone.

The optical system O according to an example shown in FIGS. 9 to 11B may be an example of being configured so that FBL/TTL has a value of 0.11 and FBL/FL has a value of 0.15. According to the test, it may be confirmed that the FWHM of the PSF has a deviation within 30% (e.g., within 5%) over all zones. For reference, the optical system O used for the test was configured to have an F-number of 2 or less (e.g., 1.8), an FOV of 40 degrees, and a distortion of 5% or less while satisfying the condition described above. The above F-number may be considered as a value sufficiently low to be used even in small-sized electronic devices such as mobile phones.

Meanwhile, a method of increasing the FWHM of the PSF in the central zone and reducing the FWHM of the PSF in the edge zone by using a distortion for each zone of the optical system (e.g., differentiating the magnification for each zone) may be used. However, in this case, image quality may be degraded due to a high distortion for each zone. For example, when the optical system has a high distortion, an additional image processing process for distortion correction may be required. However, according to the conditions of Equation 1 and Equation 2, PSFs may be uniformized while satisfying a low distortion (e.g., 5% or less). Therefore, without the need to perform an additional image processing process to compensate for the distortion, the optical system O of one or more embodiments may acquire images with sufficiently high quality through an image restoration technique with a single PSF applied.

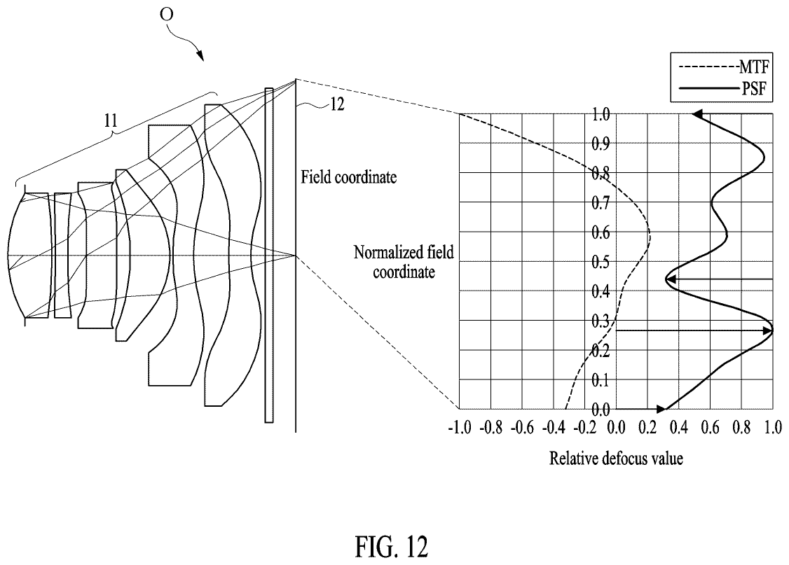

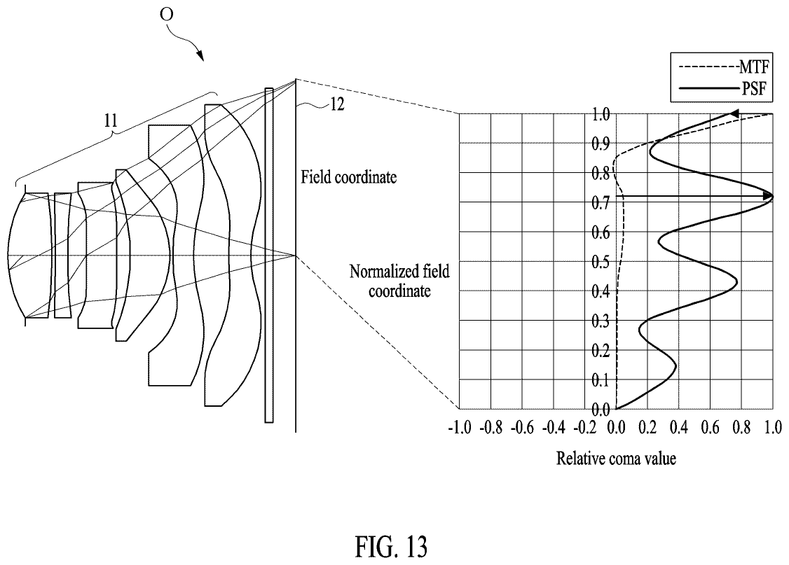

FIG. 12 illustrates an arrangement structure of an optical system according to an example, and a relative defocus value according to a field coordinate of an image sensor. FIG. 13 illustrates an arrangement structure of an optical system according to an example, and a relative coma value according to a field coordinate of an image sensor.

Referring to FIG. 12, when the length from the center of the FOV of the optical system O according to an example (e.g., see FIGS. 9 to 11B) to the vertex of the FOV of the optical system O (e.g., the diagonal half length of the image sensor 12) is denoted as F, it may be configured so that the defocus value for each position of an image formed in the image sensor 12 is at a maximum at a position whether the distance from the center of the FOV is less than 1.0 F. For example, in a reference system for MTF optimization, the defocus value is generally at a maximum at a position where the distance from the center of the FOV is 1.0 F (e.g., the vertex of the FOV). However, the optical system O according to one or more embodiments may be configured so that the defocus value is at a maximum in a zone other than the edge zone, thereby relatively reducing the defocus value in the edge zone. As a result, the optical system O of one or more embodiments may reduce blurring values in the edge zone, and may reduce the deviation of the FWHM of the PSF for each zone. For example, the defocus value in the edge zone may be neither a maximum value nor a minimum value.

For example, the optical system O according to an example may be configured so that the defocus value for each position of the image formed in the image sensor 12 is at a minimum at a position where the distance from the center of the FOV is greater than 0.0 F. For example, in the reference system for MTF optimization, the defocus value is generally at a minimum at a position where the distance from the center of the FOV is 0.0 F (e.g., the center of the FOV). In contrast, the optical system O according to one or more embodiments may increase blurring values in the central zone by increasing the defocus value in the central zone, thereby reducing the deviation of the FWHM of the PSF for each zone. Further, using the design margin resulting from this, the optical system O according to one or more embodiments may relatively reduce the defocus value in the edge zone as described above, thereby reducing blurring values in the edge zone. For example, the defocus value in the central zone may be neither a maximum value nor a minimum value.

Referring to FIG. 13, the optical system O according to an example (e.g., see FIGS. 9 to 11B) may be configured so that a coma value for each position of the image formed in the image sensor 12 is at a maximum at a position where the distance from the center of the FOV is less than 1.0 F. Here, the coma value may be construed as a value indicating an off-axis asymmetric aberration. For example, the level of asymmetry of a spread spot positioned in the edge zone may be evaluated using the coma value. For example, in the reference system for MTF optimization, the coma value is generally at a maximum at a position where the distance from the center of the FOV is 1.0 F (e.g., the vertex of the FOV). However, the optical system O according to one or more embodiments may be configured so that the coma value is at a maximum in a zone other than the edge zone, thereby relatively reducing the coma value in the edge zone. As a result, the optical system O of one or more embodiments may reduce blurring values in the edge zone, and may reduce the deviation of the FWHM of the PSF. For example, the coma value in the edge zone may be neither a maximum value nor a minimum value.

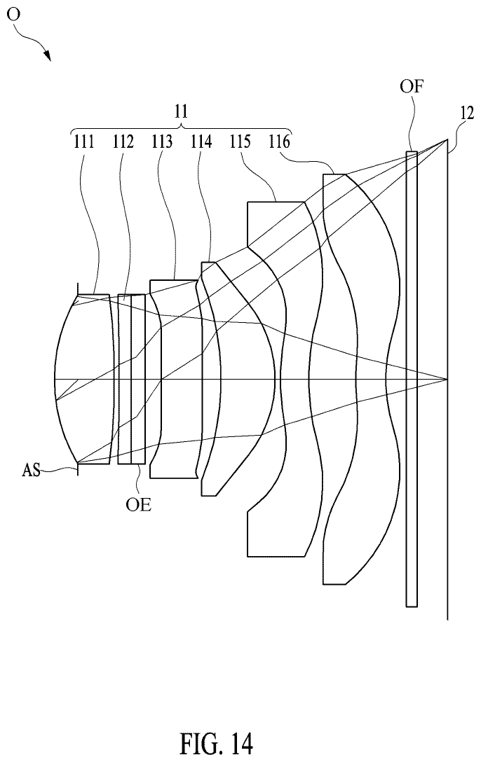

FIG. 14 illustrates an optical system according to an example.

Referring to FIG. 14, an optical system O according to an example may include an aperture stop AS, a lens assembly 11 including a plurality of lenses 111, 112, 113, 114, 115, and 116, an optical filter OF, an image sensor 12, and an additional optical element OE.

The additional optical element OE may be used to accurately compensate for an optical aberration in the optical system O and provide more uniform image quality over the entire field. The additional optical element OE may be provided on, for example, the surface of at least one of the plurality of lenses. For example, the additional optical element OE may be at least one of a diffractive optical element (DOE), a mirror, a holographic optical element (HOE), and/or a metalens. For example, the additional optical element OE may be on any one surface or both surfaces of at least one lens.

For example, at least one (e.g., all) of the plurality of lenses and/or an optical element including the additional optical element OE may be aspherical. The optical element may be formed of plastic or glass, but is not limited thereto.

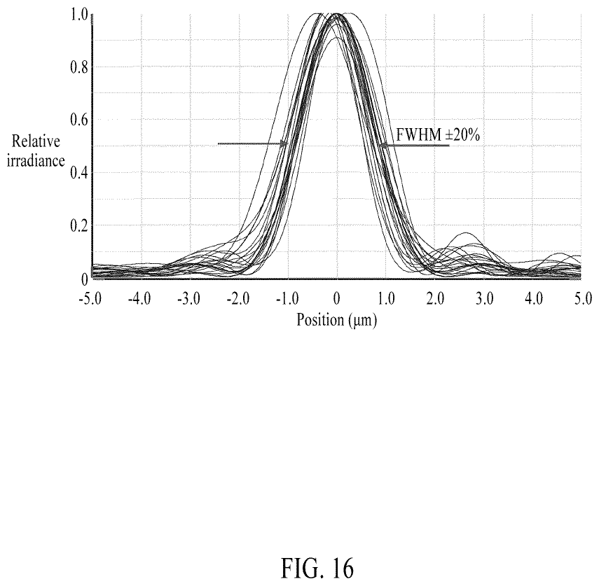

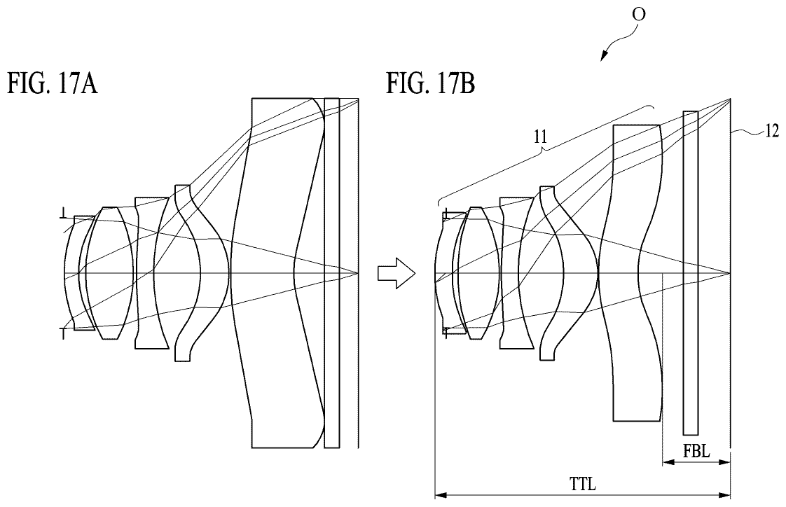

FIG. 15 illustrates an optical system according to an example. FIG. 16 illustrates a PSF for each zone of an optical system according to an example. FIGS. 17A and 17B illustrate an arrangement structure of an optical system according to an example, and an arrangement structure of an optical system according to an example.

Referring to FIGS. 15 to 17B, an optical system O according to an example may include an aperture stop AS, a lens assembly 11, an optical filter OF, and an image sensor 12. The lens assembly 11 may include a plurality of lenses.

The plurality of lenses may include (i) a first lens 111 that is positioned closest to an object side among the plurality of lenses and has a negative refractive power, (ii) a second lens 112 that is positioned closer to an image side than the first lens 111 and has a positive refractive power, (iii) a third lens 113 that is positioned closer to the image side than the second lens 112 and has a negative refractive power, (iv) a fourth lens 114 that is positioned closer to the image side than the third lens 113 and has a positive refractive power, and (v) a fifth lens 115 that is positioned closer to the image side than the fourth lens 114 and has a negative refractive power. For example, the lens assembly 11 may include the first to fifth lenses 111 to 115 described above, that is, a total of five lenses.

The optical system O may have a structure in which the PSF in the central zone increases and the PSF in the edge zone decreases, compared to a reference system for MTF optimization (e.g., see FIG. 17A). Through this configuration, the deviation of the FWHM of the PSF for each zone of the optical system O may be, for example, within 30% (e.g., within 20%) as shown in FIG. 16.

For example, as shown in FIG. 17A, the reference system may include the same number of lenses as the plurality of lenses 11 of the optical system O and an image sensor, and may be configured to MTF optimization. For example, at least one of the plurality of lenses 11 of the optical system O according to an example may have the same shape as at least one of the plurality of lenses of the reference system. For example, the plurality of lenses 11 and the image sensor 12 of the optical system O according to an example may be configured to have the same shapes as the plurality of lenses and the image sensor of the reference system, respectively, and have a different positional relationship for PSF uniformization.

According to an example, the optical system O may be configured so that the FWHM of the PSF of the optical system O for a point source positioned in the central zone of the FOV is greater than the FWHM of the PSF of the reference system and the FWHM of the PSF of the optical system O for a point source positioned in the edge zone of the FOV is smaller than the FWHM of the PSF of the reference system. To this end, the optical system O according to an example may satisfy Equation 1 and Equation 2 as described above with reference to FIGS. 9 to 11B, and a detailed description thereof will be omitted.

The optical system O according to an example shown in FIGS. 15 to 17B may be an example of being configured so that FBL/TTL has a value of 0.21 and FBL/FL has a value of 0.31. According to the test, it may be confirmed that the FWHM of the PSF has a deviation within 30% (e.g., within 20%) over all zones, as shown in FIG. 16. For reference, the optical system O used for the test was configured to have an F-number of 2 or less (e.g., 1.85), an FOV of 40 degrees, and a distortion of 5% or less while satisfying the condition described above. The above F-number may be considered as a value sufficiently low to be used even in small-sized electronic devices such as mobile phones.

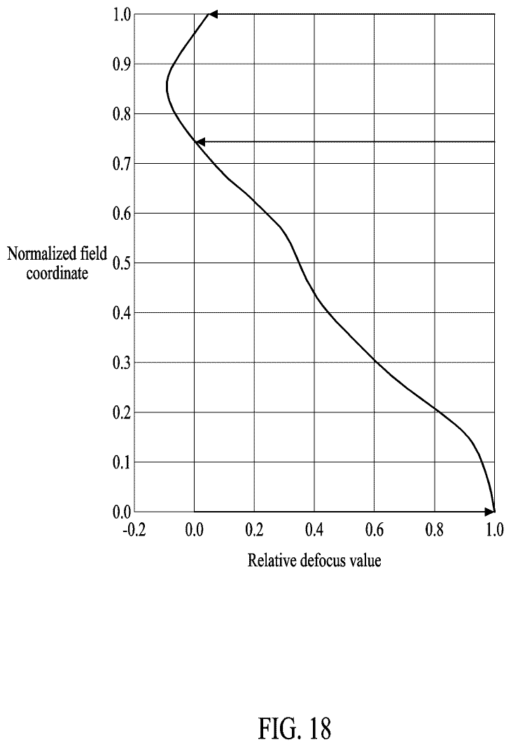

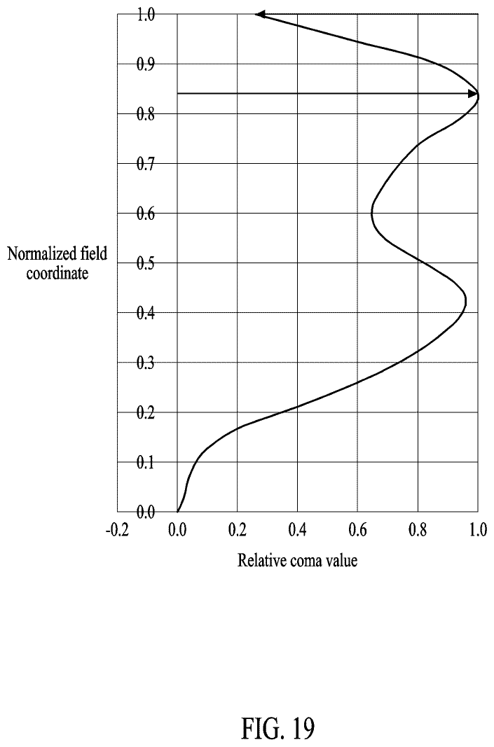

FIG. 18 illustrates a relative defocus value according to a field coordinate of an image sensor of an optical system according to an example. FIG. 19 illustrates a relative coma value according to a field coordinate of an image sensor of an optical system according to an example.

Referring to FIG. 18, when the length from the center of the FOV of the optical system O according to an example (e.g., see FIGS. 15 to 17B) to the vertex of the FOV is denoted as F, the optical system O may be configured so that the defocus value for each position of an image formed in the image sensor 12 is at a maximum at a position where the distance from the center of the FOV is less than 1.0 F. By this configuration, similar to the optical system O described with reference to FIG. 12, the optical system O of one or more embodiments may reduce blurring values in the edge zone, and may reduce the deviation of the FWHM of the PSF for each zone.

For example, the optical system O according to an example may be configured so that the defocus value for each position of the image formed in the image sensor 12 is at a minimum at a position where the distance from the center of the FOV is greater than 0.0 F. By this configuration, similar to the optical system O described with reference to FIG. 12, the optical system O of one or more embodiments may increase blurring values in the central zone, and may reduce the deviation of the FWHM of the PSF for each zone.

Referring to FIG. 19, the optical system O according to an example (e.g., see FIGS. 15 to 17B) may be configured so that the coma value for each position of the image formed in the image sensor 12 is at a maximum at a position where the distance from the center of the FOV is less than 1.0 F. By this configuration, similar to the optical system O described with reference to FIG. 13, the optical system O of one or more embodiments may reduce blurring values in the edge zone, and may reduce the deviation of the FWHM of the PSF for each zone.

Meanwhile, in the above-described examples, an example of a case where the deviation of the FWHM of the PSF for all zones of the optical system O is within 30% was described, but an image restoration technique according to an example may also be efficiently applied to a case where the deviation of the FWHM of the PSF for some zones (e.g., zones more than 80%) is within 30%. For example, the image restoration technique according to an example may also be applied to a case where the deviation of the FWHM of the PSF for zones more than ⅓ of the zones positioned in the diagonal directions of the FOV of the optical system O is within 30% (e.g., within 20% or within 5%). Hereinafter, an example of such will be described with reference to the following drawings.

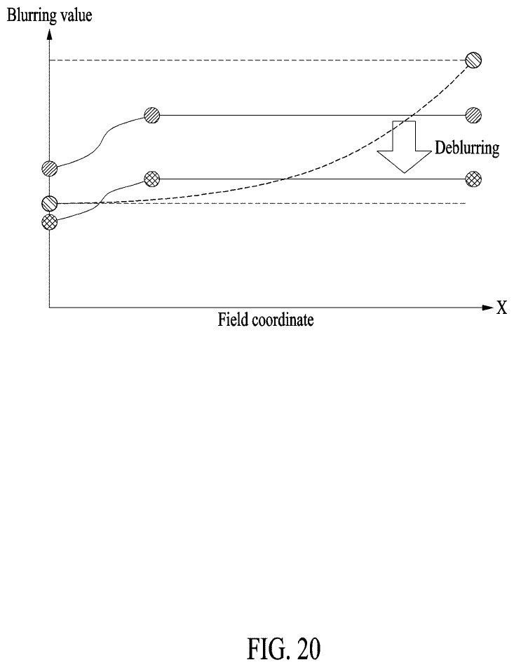

FIGS. 20 to 22 illustrate blurring values formed by an optical system according to an example, and blurring values formed by optical systems according to examples.

Referring to FIGS. 20 to 22, blurring values of an image formed by an optical system according to an example may have uniform values in some zones (e.g., zones more than ⅓). The standard for uniform values may vary depending on a set threshold value for the deviation of the FWHM of the PSF for each zone. For example, the set threshold value may be set as from 0% to 30%. For example, the set threshold value may be set as 30%, 20%, or 5%.

As shown in FIG. 20, the optical system according to an example may have uniform blurring values at a portion a predetermined distance or more spaced apart from the center of the FOV and blurring values lower than the uniform blurring values in the central zone within the predetermined distance. Here, it may be understood that the straight line portion represents the uniform blurring values and the curved portion represents blurring values in a zone departing from the deviation of the uniform blurring values. In this case, deblurring may be effectively performed by using a single PSF of any one zone (e.g., the edge zone) having uniform blurring values.

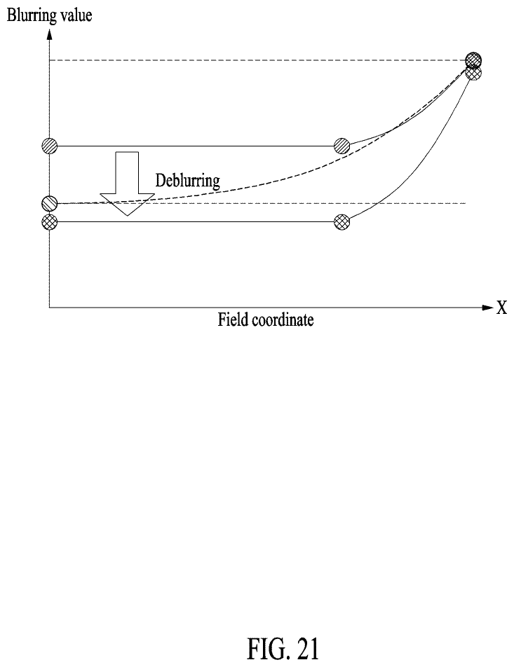

As shown in FIG. 21, the optical system according to an example may have uniform blurring values in the central zone within a predetermined distance from the center of the FOV and blurring values higher than the uniform blurring values in the edge zone beyond the predetermined distance. In this case, deblurring may be effectively performed by using a single PSF of any one zone (e.g., the central zone) having uniform blurring values.

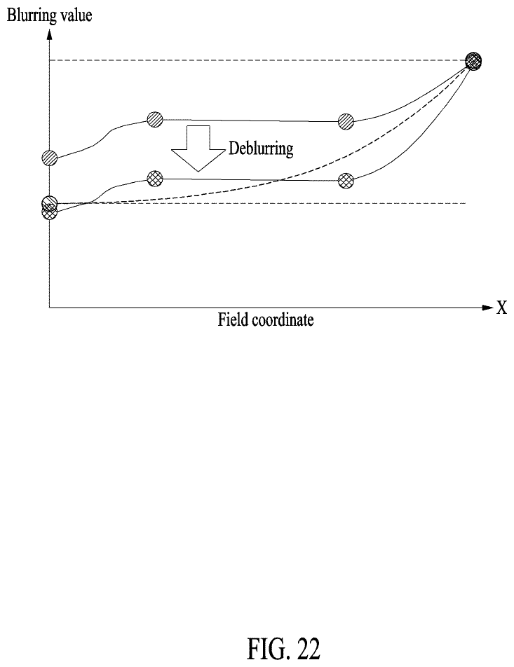

As shown in FIG. 22, the optical system according to an example may have uniform blurring values in a middle zone positioned between the central zone and the edge zone of the FOV, blurring values lower than the uniform blurring values in the central zone, and blurring values higher than the uniform blurring values in the edge zone. In this case, deblurring may be effectively performed by using a single PSF of any one zone (e.g., the middle zone) having uniform blurring values.

The electronic devices, optical systems, image sensors, memories, image signal processors, electronic device E, optical system O, image sensor 12, memory 13, and image signal processor 14 described herein, including descriptions with respect to respect to FIGS. 1-22, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-22 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical system comprising:
a lens assembly comprising a plurality of lenses; and
an image sensor configured to sense light passing through the lens assembly,
wherein, for a point light source positioned in a central zone of a field of view (FOV), a full width at half maximum (FWHM) of a point spread function (PSF) of the optical system is greater than an FWHM of a PSF of a reference system, wherein the reference system comprises a same number of lenses as the plurality of lenses and another image sensor and is configured to optimize a modulation transfer function (MTF), and
wherein, for a point light source positioned in an edge zone of the FOV, the FWHM of the PSF of the optical system is smaller than the FWHM of the PSF of the reference system.

2. The optical system of claim 1, wherein one or more of the plurality of lenses of the optical system has a same shape as one or more of the plurality of lenses of the reference system.

3. The optical system of claim 1, wherein
a ratio of a flange back length (FBL) of the optical system to an axial distance (TTL) from an object-side surface of a lens positioned closest to an object side among the plurality of lenses to the image sensor is greater than 0.10, and
a ratio of the FBL of the optical system to a focal length (FL) of the optical system is greater than 0.14.

4. The optical system of claim 1, wherein,
a length from a center of the FOV of the optical system to a vertex of the FOV of the optical system is denoted as F,
a defocus value for each position of an image formed in the image sensor is at a maximum at a position where a distance from the center of the FOV is less than 1.0 F, and
the defocus value for each position of the image formed in the image sensor is at a minimum at a position where the distance from the center of the FOV is greater than 0.0 F.

5. The optical system of claim 1, wherein,
a length from a center of the FOV of the optical system to a vertex of the FOV of the optical system is denoted as F, and
a coma value for each position of an image formed in the image sensor is at a maximum at a position where a distance from the center of the FOV is less than 1.0 F.

6. The optical system of claim 1, wherein, for a zone of 80% or more of the FOV of the optical system, a deviation of the FWHM of the PSF of the optical system is within 30%.

7. The optical system of claim 1, wherein, for a zone of ⅓ or more of a zone positioned in a diagonal direction of the FOV of the optical system, a deviation of the FWHM of the PSF of the optical system is within 30%.

8. The optical system of claim 1, wherein a distortion of the optical system is less than 5%.

9. The optical system of claim 1, wherein the plurality of lenses comprises:
a first lens that is positioned closest to an object side among the plurality of lenses and has a positive refractive power;
a second lens that is positioned closer to an image side than the first lens and has a negative refractive power;
a third lens that is positioned closer to the image side than the second lens and has a positive refractive power;
a fourth lens that is positioned closer to the image side than the third lens and has a positive refractive power;
a fifth lens that is positioned closer to the image side than the fourth lens and has a negative refractive power; and
a sixth lens that is positioned closer to the image side than the fifth lens and has a negative refractive power.

10. The optical system of claim 9, wherein the first to sixth lenses are aspherical lenses.

11. The optical system of claim 9, further comprising an infrared (IR) filter disposed between the sixth lens and the image sensor and configured to block IR radiation.

12. The optical system of claim 9, wherein the first to sixth lenses are formed of plastic.

13. The optical system of claim 1, further comprising an additional optical element placed on a surface of one or more of the plurality of lenses.

14. The optical system of claim 13, wherein the additional optical element comprises any one or any combination of any two or more of a diffractive optical element (DOE), a mirror, a holographic optical element (HOE), and a metalens.

15. The optical system of claim 1, wherein the plurality of lenses comprises:
a first lens that is positioned closest to an object side among the plurality of lenses and has a negative refractive power;
a second lens that is positioned closer to an image side than the first lens and has a positive refractive power;
a third lens that is positioned closer to the image side than the second lens and has a negative refractive power;
a fourth lens that is positioned closer to the image side than the third lens and has a positive refractive power; and
a fifth lens that is positioned closer to the image side than the fourth lens and has a negative refractive power.

16. An electronic device comprising:
the optical system of claim 1; and
one or more processors configured to deblur a plurality of zones of an image formed in the image sensor using a single PSF obtained in any one of the plurality of zones.

17. An optical system comprising:
a lens assembly comprising a plurality of lenses; and
an image sensor configured to sense light passing through the lens assembly,
wherein a ratio of a flange back length (FBL) of the optical system to an axial distance (TTL) from a portion farthest from the image sensor among the plurality of lenses to the image sensor is greater than 0.10, and
wherein a ratio of the FBL of the optical system to a focal length (FL) of the optical system is greater than 0.14.

18. An electronic device comprising:
the optical system of claim 17; and
one or more processors configured to generate a deblurred image by deblurring a plurality of zones of an image generated by the image sensor using a single point spread function (PSF) obtained in any one of the plurality of zones.

19. The electronic device of claim 18, wherein, for the deblurring, the one or more processors are configured to deblur the plurality of zones of the image generated by the image sensor without using a modulation transfer function (MTF) obtained in any one of the plurality of zones.

20. An optical system comprising:
a lens assembly comprising a plurality of lenses; and
an image sensor configured to sense light passing through the lens assembly,
wherein a distortion of the optical system is less than 5%, and
wherein, for a zone of ⅓ or more of a zone positioned in a diagonal direction of a field of view (FOV) of the optical system, a deviation of a full width at half maximum (FWHM) of a point spread function (PSF) of the optical system is within 30%.
